(19) United States
(12) Patent Application Publication
(10) Pub. No.: US 2014/0014384 A1
(43) Pub. Date: Jan. 16, 2014

(54) POWER TOOL

(71) Applicant: HITACHI KOKI CO., LTD., Tokyo (JP)

(72) Inventors: Yuki HORIE, Hitachinaka (JP); Tomomasa NISHIKAWA, Hitachinaka (JP); Takao ARADACHI, Hitachinaka (JP); Kazuhiko FUNABASHI, Hitachinaka (JP)

(21) Appl. No.: 13/937,762

(22) Filed: Jul. 9, 2013

(30) Foreign Application Priority Data
Jul. 12, 2012 (JP) 2012-156064

(51) Int. Cl. B25F 5/00

(52) U.S. Cl. CPC B25F 5/00
USPC 173/217

(57) ABSTRACT

A power tool includes a small-size lithium ion secondary battery used as its driving source, and at least one lithium ion secondary battery having a diameter of 14 mm is disposed inside a grip portion of a main body of the power tool. The lithium ion secondary battery has a sufficient output characteristic required for driving the power tool. When a switch installed in the main body of the power tool is operated by a user, electric power is supplied to a driving unit including a motor so that the power tool is activated. The lithium ion secondary battery is of a pack type, or is directly housed inside the grip portion, and the grip portion, which houses three of the lithium ion secondary batteries, is designed to have a diameter of 51.8 mm or less.

### CROSS-REFERENCE TO RELATED APPLICATION

The present application claims priority from Japanese Patent Application No. 2012-156064 filed on Jul. 12, 2012, the content of which is hereby incorporated by reference into this application.

### TECHNICAL FIELD OF THE INVENTION

The present invention relates to a power tool that uses a lithium ion secondary battery as a driving source.

### BACKGROUND OF THE INVENTION

There have been strong demands for a higher capacity and for lighter weight regarding batteries for use in a cordless power tool. In response to these demands, a lithium ion secondary battery having a high output density (hereinafter, referred to simply as “lithium ion battery”) has been utilized. More specifically, a battery pack in which a plurality of lithium ion batteries and a protective circuit are integrally installed has been used as a driving source for a power tool. In general, the above-mentioned battery pack can be detachably attached to a power tool main body. Moreover, to reduce the size of the power tool main body, Japanese Patent Application Laid-Open Publication No. 2008-270007 describes a power tool in which the battery pack is partially housed inside a grip portion of the power tool main body. In the following explanation, each of the lithium ion batteries forming the battery pack is sometimes referred to as “a battery cell”.

### SUMMARY OF THE INVENTION

As a battery pack for use as a driving source of a power tool, a battery cell in a cylindrical shape having a diameter of 18 mm and a length (height) of 65 mm is mainly used. The battery cell having such a size is generally referred to as “18650 size”. In battery packs used in cordless power tools currently sold in the market, a plurality of the battery cells of the 18650 size are connected in series with or in parallel with one after another in accordance with required battery cell voltage and battery capacity. The power tool, which uses a plurality of lithium ion batteries, has a reduced size and a reduced weight in comparison with those power tools which use the same number of nickel cadmium batteries or nickel hydrogen batteries. However, on the assumption of the use by children, females and elderly people, further downsizing and weight reduction are demanded for the power tools. Moreover, a structure is also known in which a battery cell is partially housed in a grip portion; however, when an attempt is made to house all the plurality of the 18650 size battery cells into the grip portion, the grip portion becomes thicker.

One of preferred aims of the present invention is to provide a power tool that uses a lithium ion battery having light weight and a small size with sufficient output characteristics required for driving the power tool.

Another preferred aim of the present invention is to provide a power tool that is provided with a thin grip portion that is easily grabbed by using a lithium ion battery that is thin in its diameter.

The other preferred aim of the present invention is to provide a power tool in which a battery pack provided with a protective circuit for monitoring a charging and discharging state of a battery cell is installed.

The typical characteristics of the invention disclosed in the present specification will be explained as follows.

A power tool according to one aspect of the present invention is such a power tool as to include a battery pack, which includes a plurality of battery cells, as a driving source. Each of the battery cells is, for example, a lithium ion battery referred to as “14500 size” or the like, having an actual diameter of 14 mm or less. When a switch installed in a main body of the power tool is operated, the lithium ion battery is connected to a driving unit including a motor so that the power tool is activated. The lithium ion battery and a protective circuit for protecting the lithium ion battery are installed in an independent battery pack that is capable of being detachably attached to the power tool, with the battery pack being allowed to enter the inside of a grip portion of the power tool main body. Three of the lithium ion batteries are disposed on the same surface inside the grip portion, and the grip portion has a maximum diameter of 51.8 mm or less. The protective circuit may be disposed lateral to the lithium ion batteries in parallel with the axial direction of the grip portion. Moreover, by disposing the protective circuit for protecting the lithium ion battery on an upper surface or a lower surface of the lithium ion battery, the grip portion may be designed to have a maximum diameter of 48.6 mm or less. Furthermore, by directly installing three lithium ion batteries inside the grip portion, the grip portion may be designed to have a maximum diameter of 45.6 mm or less. Alternatively, by disposing the protective circuit on an upper surface or a lower surface of the lithium ion battery, the grip portion may be designed to have a maximum diameter of 42.5 mm or less.

A power tool in accordance with another aspect of the present invention is such a power tool that uses a battery pack including a plurality of battery cells as a driving source. Each of the battery cells is a lithium ion battery having an actual diameter of 14 mm or less. When a switch installed in a main body of the power tool is operated, the lithium ion battery is connected to a driving unit including a motor so that the power tool is activated. The lithium ion battery and a protective circuit for protecting the lithium ion battery are installed in an independent battery pack that is capable of being detachably attached to the power tool, with the battery pack being allowed to enter an inside of a grip portion of the power tool main body. Two of the lithium ion batteries are installed in the grip portion so as to have the same axis as the axial line of the grip portion, with the grip portion having a maximum diameter of 45.3 mm or less. The protective circuit is disposed lateral to the lithium ion batteries in parallel with the axial direction of the grip portion. Moreover, by disposing the protective circuit on an upper surface or a lower surface of the lithium ion batteries, the grip portion may be designed to have a maximum diameter of 42.4 mm or less. Furthermore, by directly installing two lithium ion batteries inside the grip portion, the grip portion may be designed to have a maximum diameter of 39.5 mm or less. Alternatively, by disposing the protective circuit on an upper surface or a lower surface of the lithium ion batteries, the grip portion may be designed to have a maximum diameter of 36.6 mm or less.

A power tool according to another aspect of the present invention is such a power tool that uses a battery pack, which includes a plurality of battery cells, as a driving source. Each of the battery cells is a lithium ion battery having an actual diameter of 14 mm or less. When a switch installed in a main body of the power tool is operated, the lithium ion battery is connected to a driving unit including a motor so that the power tool is activated. The lithium ion battery and a protective circuit for protecting the lithium ion battery are installed in an independent battery pack that is capable of being detachably attached to the power tool, with the battery pack being allowed to enter the inside of a grip portion of the power tool main body. The single lithium ion secondary battery is housed in the grip portion, with the grip portion having a maximum diameter of 37.5 mm or less. The protective circuit may be disposed lateral to the lithium ion battery in parallel with the axial direction of the grip portion. Moreover, by directly installing the single lithium ion battery in the grip portion, the grip portion may be designed to have a maximum diameter of 34.9 mm or less. In this case, the protective circuit is disposed lateral to the lithium ion battery in parallel with the axial direction of the grip portion. Furthermore, by disposing the protective circuit on an upper surface or a lower surface of the lithium ion battery, the grip portion may be designed to have a maximum diameter of 32.2 mm or less.

According to one aspect of the present invention, since the battery pack is allowed to enter the inside of a grip portion of the power tool main body, with three of the lithium ion batteries being disposed in the same direction as the axial direction of the grip portion, and the grip portion has a maximum diameter of 51.8 mm or less. Therefore, it is possible to achieve a power tool having light weight and a small size, with its grip portion being sufficiently thinned and easily grabbed.

According to another aspect of the present invention, the three lithium ion batteries are installed in the grip portion on the same axis as the axial line of the grip portion, with the grip portion having a maximum diameter of 45.6 mm or less. Therefore, 84% of males are able to grab the grip portion by the use of the index finger.

In accordance with still another aspect of the present invention, the lithium ion battery and a protective circuit for protecting the lithium ion battery are installed in an independent battery pack that is capable of being detachably attached to the power tool main body, with the battery pack being allowed to enter the inside of a grip portion of the power tool main body. Moreover, two of the lithium ion batteries are installed in the grip portion so as to have the same axis as the axial line of the grip portion, with the grip portion having a maximum diameter of 45.3 mm or less. Therefore, 84% of males are able to grab the grip portion by the use of the index finger.

According to still another aspect of the present invention, the two lithium ion batteries are installed in the grip portion on the same axis as the axial line of the grip portion, with the grip portion having a maximum diameter of 39.5 mm or less. Therefore, 84% of females are able to grab the grip portion by the use of the index finger.

According to still another aspect of the present invention, since the battery pack is allowed to enter the inside of a grip portion of the power tool main body, with the single lithium ion battery being disposed in the grip portion, and the grip portion has a maximum diameter of 37.5 mm or less. Therefore, more than half the females are able to grab the grip portion by the use of the index finger.

According to the other aspect of the present invention, the single lithium ion battery is disposed in the grip portion, and the grip portion has a maximum diameter of 34.9 mm or less. Therefore, 84% of females are allowed to grab the grip portion by the use of the index finger.

### BRIEF DESCRIPTIONS OF THE DRAWINGS

FIG. 1A is a longitudinal cross-sectional view showing a power tool (10.8 V impact driver) according to a first embodiment;

FIG. 1B is a cross-sectional view taken along the line A-A of FIG. 1A;

FIG. 2A is a longitudinal cross-sectional view showing a first modification example of the power tool according to the first embodiment;

FIG. 2B is a cross-sectional view taken along the line B-B of FIG. 2A;

FIG. 3A is a longitudinal cross-sectional view showing a second modification example of the power tool according to the first embodiment;

FIG. 3B is a cross-sectional view taken along the line C-C of FIG. 3A;

FIG. 4A is a longitudinal cross-sectional view showing a third modification example of the power tool according to the first embodiment;

FIG. 4B is a cross-sectional view taken along the line D-D of FIG. 4A;

FIG. 5A is a longitudinal cross-sectional view showing a power tool (7.2 V driver drill) according to a second embodiment;

FIG. 5B is a cross-sectional view taken along the line E-E of FIG. 5A;

FIG. 6 is a circuit block diagram relating to the power tool according to the second embodiment;

FIG. 7A is a longitudinal cross-sectional view showing a first modification example of the power tool according to the second embodiment;

FIG. 7B is a cross-sectional view taken along the line F-F of FIG. 7A;

FIG. 8A is a longitudinal cross-sectional view showing a second modification example of the power tool according to the second embodiment;

FIG. 8B is a cross-sectional view taken along the line G-G of FIG. 8A;

FIG. 9 is a circuit block diagram relating to the power tool according to the second embodiment;

FIG. 10A is a longitudinal cross-sectional view showing a third modification example of the power tool according to the second embodiment;

FIG. 10B is a cross-sectional view taken along the line H-H portion of FIG. 10A;

FIG. 11A is a longitudinal cross-sectional view showing a power tool (3.6 V driver drill) according to a third embodiment;

FIG. 11B is a cross-sectional view taken along the line I-I of FIG. 11A;

FIG. 12A is a longitudinal cross-sectional view showing a first modification example of the power tool according to the third embodiment;

FIG. 12B is a cross-sectional view taken along the line J-J of FIG. 12A;

FIG. 13A is a longitudinal cross-sectional view showing a second modification example of the power tool in accordance with the third embodiment; and

FIG. 13B is a cross-sectional view taken along a K-K portion of FIG. 13A.

### DESCRIPTIONS OF THE PREFERRED EMBODIMENTS

### First Embodiment

Hereinafter, embodiments of the present invention will be described in detail with reference to the accompanying drawings.

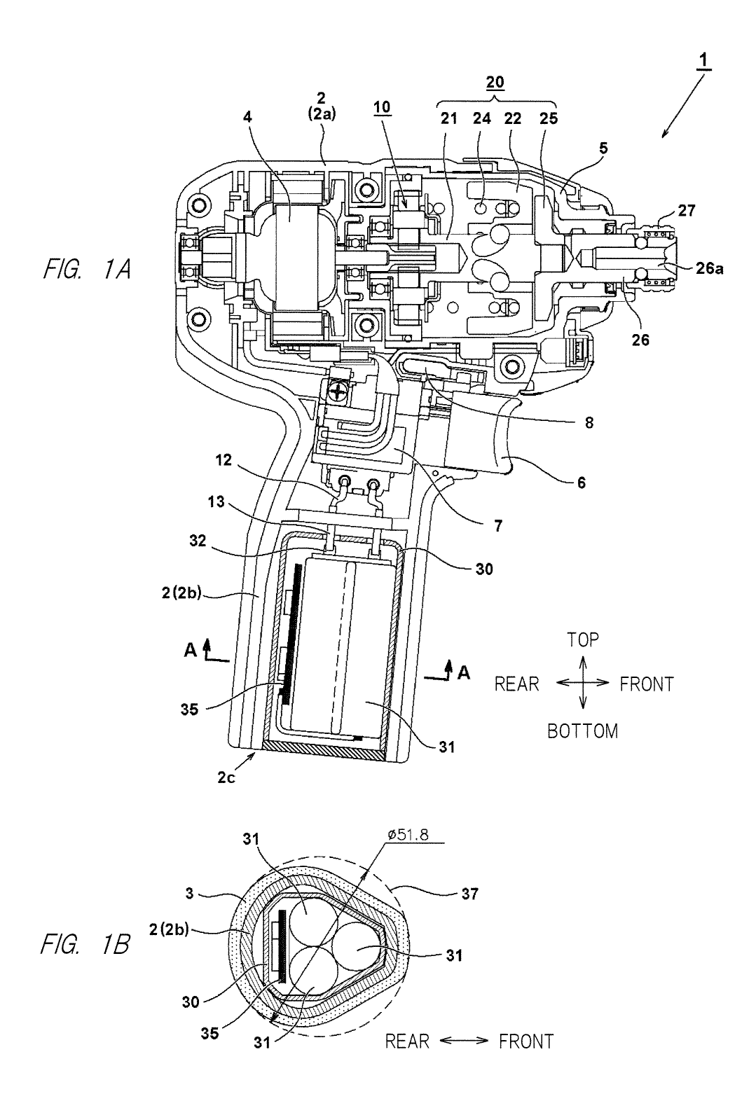

Note that the same components (parts) are denoted by the same reference symbols throughout the drawings described in the following, and the repetitive description thereof will be omitted. In the present specification, descriptions will be made taking horizontal and vertical directions as those illustrated in FIG. 1.

A power tool 1 is provided with a rechargeable battery pack 30 as a power supply and a motor 4 as a driving source. In the power tool 1, a rotary force and an impact force are given to an output shaft 26 via a power transmission mechanism. When the rotary force and the impact force are given to the output shaft 26, a rotary impact force is intermittently transmitted to a tip tool, not shown, such as a driver bit or the like held in a mounting hole 26a covered with a sleeve 27, and a job, such as a screw tightening job or a bolt tightening job, is carried out by the tip tool. The motor 4, which is a DC motor with a brush for use as a driving source for rotating the tip tool, not shown, is housed in a cylindrical body portion 2a of a housing 2 having a substantially T-letter shape when seen in a plan view. The rotating shaft of the motor 4 is connected to the power transmission mechanism so as to rotate the tip tool. In the present embodiment, the power transmission mechanism is constituted by a reducer mechanism 10 using planetary gears and an impact mechanism 20 having a hammer 22 and an anvil 25. The reducer mechanism 10 is provided with a sun gear attached to the rotating shaft of the motor 4, the plural planetary gears, and a fixed-type ring gear located on the peripheral side of the planetary gears, and the rotating shafts of the plural planetary gears rotate a fixed planetary carrier. The impact mechanism 20 may be formed by using a known widely-used impact mechanism, which includes a spindle 21 connected to the planetary carrier, a hammer 22 capable of shifting in axial directions, a spring 24 that presses the hammer 22, cam grooves, balls and the like.

A housing (case or frame of the power tool) in its broad sense of the word in the present embodiment is composed of a housing 2 and a hammer case 5 placed on the front side thereof. The housing 2 is provided with a right-side member and a left-side member molded with a synthetic resin, such as a plastic material, and the right-side member and the left-side member are secured by a plurality of screws, not shown. The hammer case 5 is molded by using metal, such as an aluminum alloy or the like. The hammer case 5 has a cylindrical shape with its tip being thinned, and sandwiched by tip end sides of a body portion 2a of the housing 2 having right and left divided portions. On an upper portion inside a grip portion 2b that is integrally extended from the body portion 2a of the housing 2 substantially at right angles, a switch 7 is disposed, and on its front side, a trigger 6 for use in operating the switch 7 is formed. The switch 7 is a variable switch for use in adjusting the amount of electric power to be supplied from the battery pack 30 to the motor 4, and the speed of the motor 4 is adjusted by a pulling operation of the trigger 6. On the upper side of the trigger 6, a forward/reverse switchover switch 8 for use in switching the rotating direction of the rotor 4 is installed. The switch 7 is connected to a terminal 13 through a lead wire 12. The terminal 13, which is a metal terminal attached to the housing 2, is connected to a connector 32 of the battery pack 30 when the battery pack 30 is mounted. Although only two metal terminals are seen in the drawing, three or more metal terminals may be installed. In an internal space on the lower side of the grip portion 2b, the battery pack 30 including three lithium ion batteries (battery cells 31) is installed. FIG. 1 shows a state in which the battery pack 30 is mounted on a predetermined position in the inner space of the grip portion 2b. As shown in the drawing, the battery pack 30 is housed in a manner so as not to protrude downward from an opening 2c of the grip portion 2b. The lower surface of the battery pack 30 thus mounted is allowed to seal the opening 2c on the lower side of the grip portion 2b to form one portion of an outside frame of the housing 2. Additionally, the battery pack 30 as shown in the drawing is completely housed inside the grip portion 2b of the housing 2. However, one portion of the battery pack 30 may be housed inside the housing 2, with the rest of the portion being exposed to the outside of the housing 2.

The battery pack 30 includes a case and the three battery cells 31 housed inside the case, and each of the battery cells 31 has a cylindrical shape. The battery pack 30 is disposed such that the upward and downward directions of the battery cells 31, that is, axial directions (longitudinal directions) of the battery cells 31, are coincident with the longitudinal directions (upward and downward directions) of the grip portion 2b. One of the battery cells 31 is disposed in an upside-down direction to the other two battery cells 31, and the three battery cells 31 are connected in series with one another. The battery cells 31 in the present embodiment are lithium ion batteries, each having a so-called 14500 size having a rated voltage of 3.6 V. The lithium battery of the 14500 size refers to a lithium ion battery having a cylindrical shape, with 14 mm in diameter and 50 mm in length, which has the same size as that of a commercially-available dry cell battery of size AA (R6 size, AA size). Inside the battery pack 30, a circuit board 35 with a protective circuit for protecting the battery cells 31 mounted thereon is installed. The circuit board 35 is a substrate having substantially a rectangular shape. The circuit board 35 is disposed lateral to the battery cells 31, with its main surface being made in parallel with the longitudinal direction of the battery cells 31. Two latch portions, not shown, are formed on the battery pack 30. These latch portions are engaged with concave portions (not shown) formed on inner walls of the housing 2 so as to hold the battery pack 30. Upon detaching the battery pack 30, the battery pack 30 is pulled downward from the opening 2c, with the latch portions being pressed.

FIG. 1B is a cross-sectional view taken along the A-A portion of FIG. 1A. The battery pack 30 is housed inside the grip portion 2b of the housing 2. When seen in its cross section, the battery pack 30 has a minimum size required for housing the three battery cells 31 and the circuit board 35 placed lateral to the battery cells 31. The battery pack 30 has a cross-sectional shape (outline shape) having substantially a triangular shape (or a rounded triangle shape), and the shape of the housing 2 is also determined in accordance with the shape of the battery pack 30. Additionally, in the present embodiment, the housing 2, formed of a synthetic resin, such as a plastic material or the like, is covered with an elastic member 3. Therefore, a worker feels elasticity when he or she grabs the housing 2 including the grip portion 2b, and the housing 2 is hardly slippery and easily handled. For example, a thermoplastic elastomer is used as the elastic member 3. In the present embodiment, the diameter (outer diameter) at the outermost position of the elastic member 3, approximated by a round virtual line 37, is 51.8 mm. That is, the grip portion 2b is sufficiently narrow, and has such a size as to be easily grabbed by most workers. According to statistic data, the average value of the inner diameter of a grip (index finger) of the right hand of Japanese males is 41.7 mm and the standard deviation σ thereof is 2.83 mm. Therefore, when the diameter of the grip portion 2b is larger than 51.8 mm, 84% or more of male fingers fail to reach. In other words, most of males can to comfortably grab the grip portion 2b of the present embodiment. Moreover, since the circuit board 35 is disposed lateral to the battery cells 31 in parallel with the axial direction of the grip portion 2b, the length in the axial direction of the grip portion 2b becomes shorter so that the power tool 1 can be downsized.

When the trigger 6 of the power tool 1 is pulled, the motor 4 is activated. The rotation of the motor 4 is decelerated by the reducer mechanism 10 so that the spindle 21 of the impact mechanism 20 is rotated at a number of revolutions at a predetermined ratio relative to the number of revolutions of the motor 4. When the spindle 21 rotates, its rotary force is transmitted to the anvil 25 through the hammer 22, and the output shaft 26 integrally formed with the anvil 25 is rotated at the same speed as that of the spindle 21. Moreover, when the force to be applied to the anvil 25 becomes greater due to a repulsive force received from the tip tool side, the hammer 22 is allowed to retreat toward the motor 4 side while compressing the spring 24 along the spindle cam grooves of the cam mechanism. Then, when the convex portion of the hammer 22 gets over the convex portion of the anvil 25 by the retreating movement of the hammer 22 so that the engagement between the two members is released, the hammer 22 is shifted forward, while being rapidly accelerated forward as well as in the rotation direction, by the rotating force of the spindle 21, elastic energy accumulated in the spring 24 and the action of the cam mechanism, and its convex portion is again engaged with the next convex portion of the anvil 25 away from the former one by 180 degrees to be integrally rotated. At this time, since a strong rotary impact force is applied to the anvil 25, the rotary impact force is transmitted to a screw via the tip tool, not shown, attached to the output shaft 26 that is integrally coupled to the anvil 25. Thereafter, the same operations are repeated, and the rotary impact force is intermittently transmitted from the tip tool to the screw repeatedly so that, for example, the screw is screwed into a material to be fastened, such as a lumber or the like, not shown.

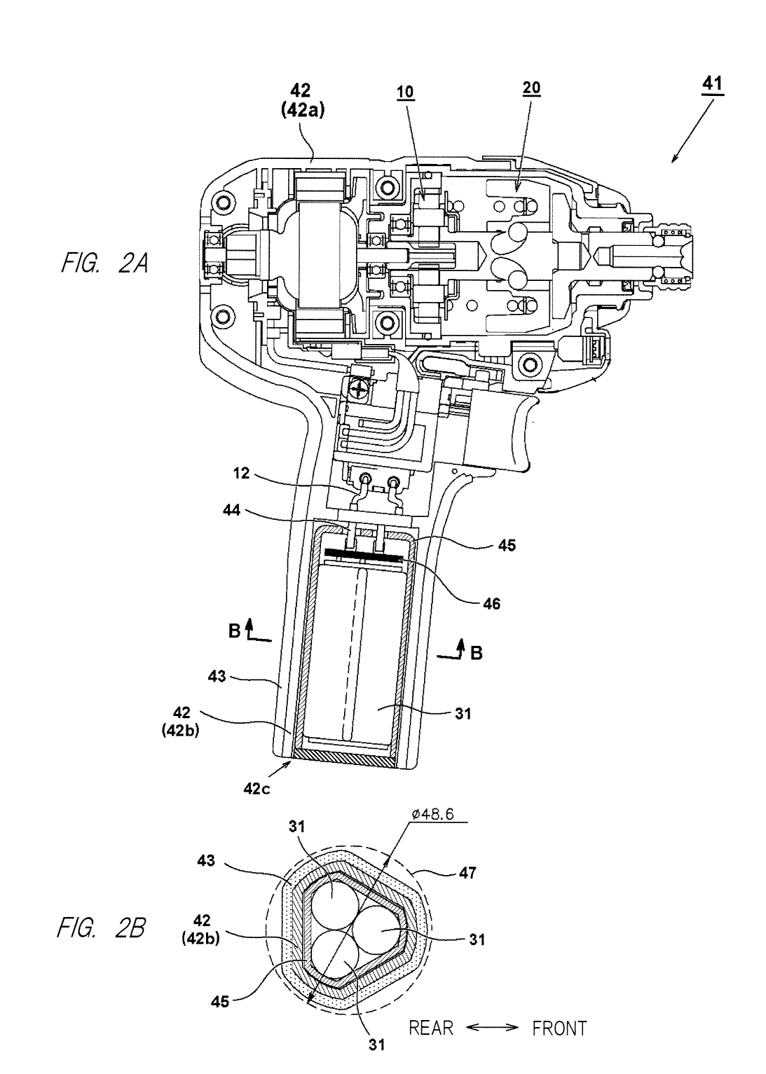

Next, referring to FIGS. 2A and 2B, the following description will explain a first modification example of the power tool according to the present embodiment. FIG. 2A is a longitudinal cross-sectional view showing the entire structure of a power tool 41 (10.8 V impact driver) relating to the present modification example. Moreover, FIG. 2B is a cross-sectional view taken along a B-B portion of FIG. 2A. The basic structure of the power tool 41 is the same as that of the power tool 1 shown in FIG. 1. More specifically, three battery cells 31 and a circuit board 46 with a protective circuit for the battery cells 31 mounted thereon are housed in a battery pack 45 that can be detachably attached. In this case, a shape of a housing 42, in particular, a shape of a grip portion 42b and the battery pack 45 to be housed therein are different from those of the first embodiment. Inside the battery pack 45, three battery cells 31, each having a cylindrical shape, are disposed in a manner so as to make the upward and downward directions of the battery cells 31, that is, the axial direction (longitudinal direction) of the battery cells 31, coincident with the longitudinal direction (vertical directions) of the grip portion 42b. However, the circuit board 46 having the protective circuit for protecting the battery cells 31 mounted thereon is disposed between the end portion of the battery cells 31 and a terminal 44. The circuit board is disposed so as to make its main surface substantially perpendicular to the axial direction of the battery pack 45.

FIG. 2B is a cross-sectional view taken along the B-B portion of FIG. 2A. The battery pack 45 is housed inside a grip portion 42b of the housing 42. When seen in its cross section, the battery pack 45 has a minimum size required for housing the three battery cells 31. The battery pack 45 has a cross-sectional shape (outline shape) having substantially a triangular shape (or a rounded triangle shape), and the shape of the housing 42 is also determined in accordance with the shape of the battery pack 45. The housing 42 is covered with an elastic member 43. In the present modification example, the diameter (outer diameter) at the outermost position of the elastic member 43, approximated by a round virtual line 47, is 48.6 mm. Therefore, the grip portion 42b is sufficiently narrow, and has such a size as to be easily grabbed by most of workers. More specifically, with respect to not less than half the number of males who grab the grip portion 42b, the thumb and the tip of the index finger touch each other.

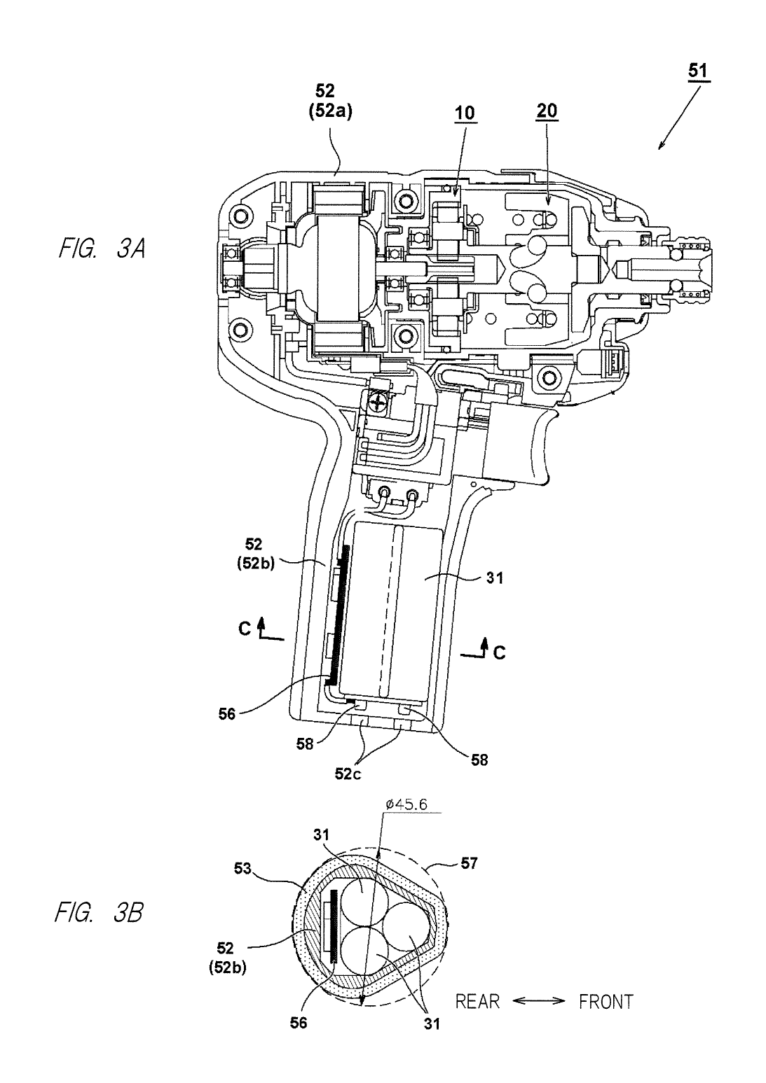

Next, referring to FIGS. 3A and 3B, the following description will explain a second modification example of the power tool in accordance with the present embodiment. FIG. 3A is a longitudinal cross-sectional view showing the entire structure of a power tool 51 (10.8 V impact driver) relating to the present modification example. Moreover, FIG. 3B is a cross-sectional view taken along a C-C portion of FIG. 3A. The basic structure of the power tool 51 is the same as that of the power tool 1 shown in FIG. 1; however, the shape of a housing 52, in particular, the shape of a grip portion 52b, is different. Moreover, it is also different from the power tool 1 shown in FIG. 1 in that battery cells 31 are installed in the grip portion 52b in a manner so as neither to be detachable nor to be attachable. In this case, the state in which they are neither detachable nor attachable means that the worker cannot easily carry out the detaching process without using a tool. Therefore, the housing 2 can be disassembled by removing screws that secure the right-side member and the left-side member of the housing 2 in a service center or the like so that the battery cells 31 can be removed from the housing 2. Inside the grip portion 52b, three battery cells 31, each having a cylindrical shape, are disposed in a manner so as to make the vertical direction of the battery cells 31, that is, the axial direction (longitudinal direction) of the battery cells 31, coincident with the longitudinal direction (vertical direction) of the grip portion 52b. Moreover, a circuit board 56 having a protective circuit for protecting the battery cells 31 mounted thereon is disposed being lateral to the battery cells 31 so as to be in parallel with the battery cells 31. On the lower surface of the housing 52, a through hole 52c to which a connection-use connector of an external charger, not shown, is inserted is formed. Inside of the through hole 52c, a socket 58 to be connected to the connection-use connector is installed.

FIG. 3B is a cross-sectional view taken along the C-C portion of FIG. 3A. The three battery cells 31 and the circuit board 56 are housed inside the grip portion 52b of the housing 52. When seen in its cross section, the grip portion 52b of the housing 52 has a minimum size required for housing the three battery cells 31 and the circuit board 56. The grip portion 52b has a cross-sectional shape (outline shape) having substantially a triangular shape (or a rounded triangle shape). The housing 52 is covered with an elastic member 53. In the present embodiment, the outer diameter of the elastic member 53, approximated by a round virtual line 57, is 45.6 mm. Therefore, the grip portion 52b is sufficiently narrow, and has such a size as to be easily grabbed by most of workers. More specifically, with respect 84% or more of males who grab the grip portion 52b, the thumb and the tip of the index finger are allowed to touch each other.

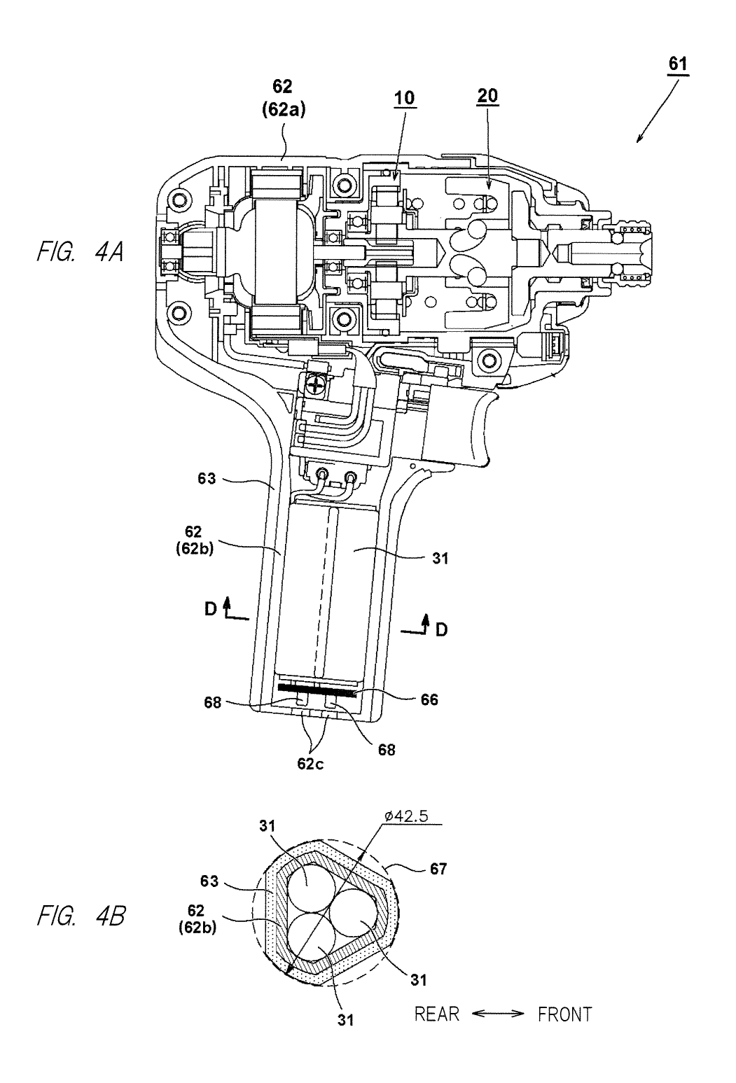

Next, referring to FIGS. 4A and 4B, the following description will explain a third modification example of the power tool according to the present embodiment. FIG. 4A is a longitudinal cross-sectional view showing the entire structure of a power tool 61 (10.8 V impact driver) relating to the present modification example. Moreover, FIG. 4B is a cross-sectional view taken along the D-D portion of FIG. 4A. The basic structure of the power tool 61 is the same as that of the power tool 1 shown in FIG. 1; however, the shape of a housing 62, in particular, the shape of a grip portion 62b, is different. Inside the grip portion 62b, three battery cells 31, each having a cylindrical shape, are disposed in a manner so as to make the upward and downward directions of the battery cells 31, that is, the axial direction (longitudinal direction) of the battery cells 31, coincident with the longitudinal direction (upward and downward directions) of the grip portion 62b. Moreover, a circuit board 66 with a protective circuit for protecting the battery cells 31 mounted thereon is disposed below the battery cells 31 inside the housing 62. On the circuit board 66, a socket 68 to which a connection-use connector that extends from an external charger, not shown, is connected is installed, with a through hole 62c that communicates with the socket 68 being formed on the housing 62. The circuit board 66 is disposed so as to be substantially perpendicular to the axial direction of the battery cells 31.

FIG. 4B is a cross-sectional view taken along a D-D portion of FIG. 4A. Three battery cells 31 are housed inside the grip portion 62b of the housing 62. When seen in its cross section, the housing 62 has a minimum size required for housing the three battery cells 31. The grip portion 62b has a cross-sectional shape (outline shape) having substantially a triangular shape (or a rounded triangle shape). Additionally, the housing 62 of the present modification example is also covered with an elastic member 63. Therefore, a worker feels elasticity when he or she grabs the housing 2 including the grip portion 62b, and the housing 2 is hardly slippery and easily handled. In the present modification example, the outer diameter of the elastic member 63, approximated by a round virtual line 67, is 42.5 mm. That is, the grip portion 62b is sufficiently narrow, and has such a size as to be easily grabbed by most of workers. More specifically, with respect to 96% or more of Japanese males who grab the grip portion 62b, the thumb and the tip of the index finger are allowed to touch each other.

As described above, the diameter of the grip portion of the power tool relating to the first embodiment and modification examples thereof is 51.8 mm at maximum and is 42.5 mm at minimum. Therefore, a small-size power tool having a thin grip portion that is easily used can be achieved. In this case, as the battery cells 31, lithium ion batteries, each having a diameter that is actually 14 mm or less, are used, and these battery cells 31 have a sufficient output characteristic for use in driving a power tool.

### Second Embodiment

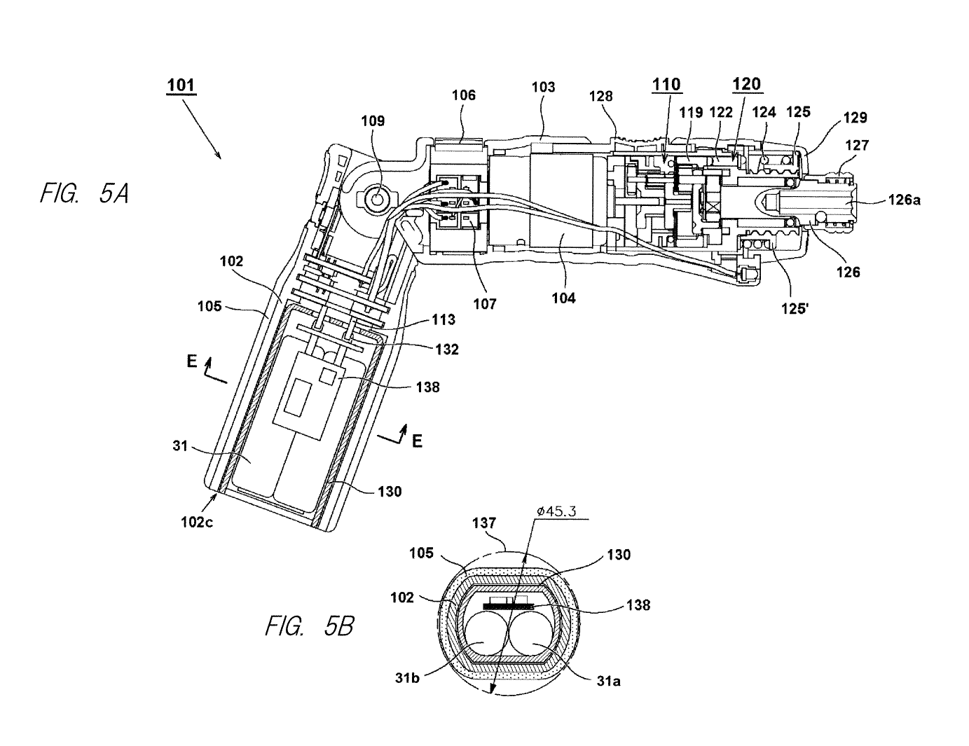

With reference to FIGS. 5 to 10, the following description will explain a second embodiment of a power tool in accordance with the present invention. The power tool of the present embodiment is a driver drill in which two lithium ion batteries (battery cells 31) of the 14500 size are used. FIG. 5A is a longitudinal cross-sectional view showing the entire structure of a power tool 101 (7.2 V driver drill) in accordance with the present embodiment. Moreover, FIG. 5B is a cross-sectional view taken along the E-E portion of FIG. 5A.

In the power tool 101, electric power is supplied from a battery pack 130 to a motor 104 serving as a driving source. The battery pack 130 is a cassette-type battery pack having a substantially cylindrical shape, which can be attached to and detached from the inner space from an opening 102c at the end portion of a housing 102. Two latch portions, not shown, are formed on the battery pack 130. These latch portions are engaged with concave portions (not shown) formed on inner walls of the housing 102 so as to hold the battery pack 130. Upon detaching the battery pack 130, the battery pack 130 is pulled through the opening 102c, while pressing the latch portions. The shape of the rear end of the battery pack 130 is formed so as to cover the opening 102c of the housing 102. A circuit board 138 having a protective circuit for protecting the battery cells 31 mounted thereon is installed lateral to the battery cells 31. The circuit board 138 is a substrate having substantially a rectangular shape. The circuit board 138 is disposed on the side of the battery cells 31, with its main surface being made in parallel with the longitudinal direction of the battery cells 31. On the front end portion (upper side in the drawings) of the battery pack 130, a plurality of terminals 132 are installed. When the battery pack 130 is attached to the housing 102, the terminals 132 are made in contact with terminals 113 of the power tool 101.

The rotation of the motor 104 is decelerated by a reducer mechanism unit 110 and transmitted to an output shaft 126 via a clutch mechanism unit 120 so that the output shaft 126 rotates at a predetermined speed. The reducer mechanism unit 110 is constituted by, for example, a planetary gear reducer mechanism (varying-speed gear case) of three steps, which is meshed with a pinion gear on the rotation shaft of the motor 104. Moreover, the reducer mechanism unit 110 is provided with a shift knob 128 for use in switching varying-speed ratios. Switching is alternatively made between a low-speed varying-speed ratio and a high-speed varying-speed ratio by a switching operation of the shift knob 128 manually carried out by the worker. The housing of the power tool 101 is composed of a motor housing 103 and a housing 102. The motor housing 103 and the housing 102 are pivotable by about 70 degrees centered on a pivotal shaft 109. The motor housing 103 and the housing 102 can be changed in their shapes into a so-called gun-type in which they are pivoted as shown in FIG. 5A and a so-called straight-type in which, although not shown in the drawings, the motor housing 103 and the housing 102 are aligned on the same axis. The motor housing 103 is constituted by a right-side member and a left-side member formed with a synthetic resin, such as a plastic material, and the right-side member and the left-side member are secured to each other by screws, not shown. That is, the motor housing 103 can be divided into right and left two portions.

The clutch mechanism unit 120 that is disposed on the tip end side of the motor housing 103 controls whether or not a rotational torque obtained by the output shaft of the reducer mechanism unit 110 is transmitted to the output shaft 126 in response to a load. In this manner, when a desired tightening torque (load torque) has been preliminarily set by using a dial 129 for use in adjusting a torque and switching modes, the output shaft of the clutch mechanism unit 120 is kept in an idling state when the rotating force of the output shaft of the reducer mechanism unit 110 has reached the set tightening torque, so that the transmission of the rotating force from the reducer mechanism unit 110 to the output shaft 126 is shut down.

The clutch mechanism unit 120 includes a pin 122 serving as a clutch claw, a clutch claw formed on the front end face of a ring gear 119 forming a planetary gear reducer mechanism on the third stage, a coil spring 124 that presses the pin 122 rearward in the axial direction and a pressing member 125 capable of shifting in the axial direction on the front side of the coil spring 124. The pressing member 125 rotates in synchronization with the rotation of the dial 129, and when the dial 129 is operated to rotate, the pressing member 125 is moved in the axial direction. By the movement of the pressing member 125 in the axial direction (frontward or rearward), the strength of the rearward pressing force of the pin 122 is adjusted so that the tightening torque (load torque) is adjusted. Additionally, in FIG. 5A, the cross section of the pressing member 125 located at the frontmost position is shown on the upper side of the output shaft 126, and the cross section of a pressing member 125′ located at the last position is shown on the lower side of the output shaft 126. In FIGS. 5A and 5B, to facilitate understanding, the pressing member 125 and the pressing member 125′ are virtually illustrated asymmetrically with respect to the upper and lower sides. In the drawing, the pressing member 125 is shown at a position at which its coil spring 124 being most extended prior to the rotation of the dial 129. On the other hand, in the drawing, the pressing member 125′ is shown at a position of the pressing member 125 with its coil spring 124 being compressed after the dial 129 has been rotated. The pressing member 125 is a ring-shaped member that continues in the circumferential direction, and actually has a symmetrical shape with respect to the upper and lower sides.

FIG. 5B is a cross-sectional view taken along the E-E portion of FIG. 5A. Inside the housing 102, the battery pack 130 including two battery cells 31 and the circuit board 138 is installed. When seen in its cross section, the housing 102 has the minimum size required for housing the two battery cells 31 and the circuit board 138. The housing 102 has a cross-sectional shape (outline shape) in which opposing two portions of a circle are squashed to be partially made in parallel with each other. The circuit board 138 with a circuit for protecting the battery cells 31 mounted thereon is disposed lateral to the battery cells 31 inside the battery pack 130 in a manner so as to be in parallel with the battery cells 31. The housing 102 in the present embodiment is also covered with the elastic member 105, and the maximum outer diameter of the elastic member 105 approximated by a round virtual line 137 is 45.3 mm. Therefore, the grip portion is sufficiently thin and is easily grabbed by most of the workers. The average value of the inner diameter of a grip (index finger) of the hand of a Japanese female is 37.5 mm and the standard deviation σ thereof is 2.68 mm. Therefore, when the grip diameter becomes larger than 45.3 mm, the fingers of the females of 84% or more fail to reach, with the result that the power tool is not used comfortably.

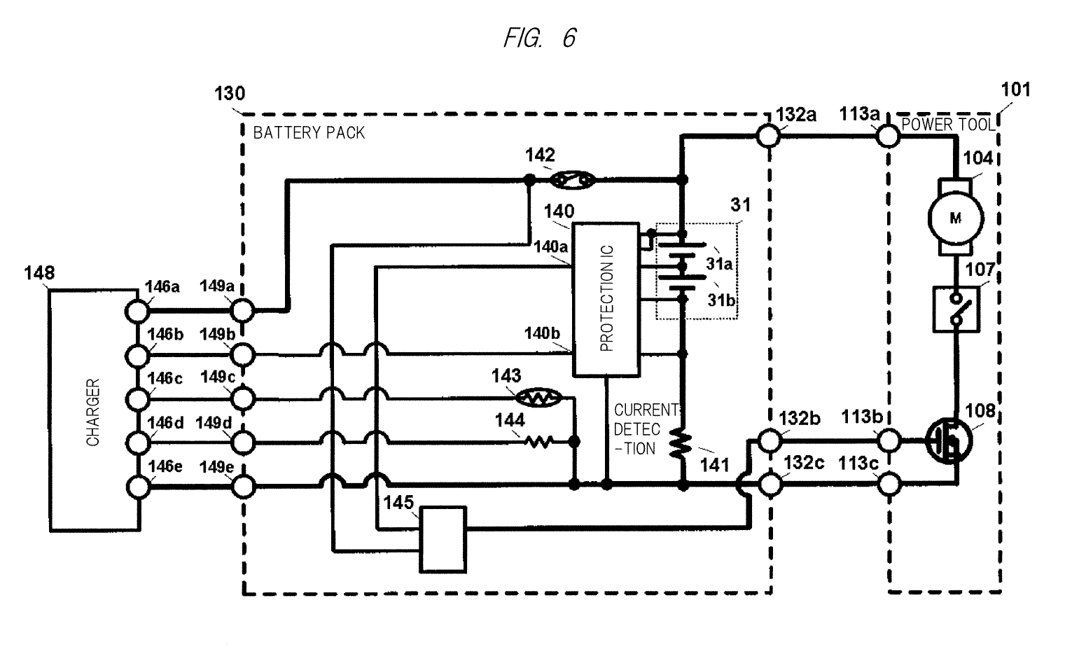

FIG. 6 is a circuit block diagram relating to the power tool 101 according to the present embodiment. A charging device 148 is prepared separately from the power tool 101, and corresponds to a known charging means for charging the battery pack 130 by using a commercial power supply. In FIG. 6, the three devices, i.e., the charging device 148, the battery pack 130 and the power tool 101 are illustrated as if they were simultaneously connected to one another; however, actually, the charging device 148 and the battery pack 130 are simultaneously connected to each other, or alternatively, the battery pack 130 and the power tool 101 are simultaneously connected to each other. That is, the three devices of the charging device 148, the battery pack 130 and the power tool 101 are not simultaneously connected.

To the charging device 148, the battery pack 130, detached from the power tool 101, can be detachably attached. When charging of the battery pack 130 is required, the battery pack 130 is detached from the power tool 101, and is attached to the charging device 148. Upon using the power tool 101, and when no charging is required for the battery pack 130, the battery pack 130 is detached from the charging device 148. The protective circuit included in the battery pack 130 includes a protective IC 140, an FET control circuit 145, a thermal protector 142, a thermistor 143 and a discrimination resistor 144. Two battery cells 31a and 31b are housed in the battery pack 130, and connected in series with each other.

In the present embodiment, the protective circuit, constituted by the protective IC 140, the FET control circuit 145 and the like, is housed in the battery pack 130. As a result, since it is only necessary to form the FET 108 serving as a switching means for carrying out ON/OFF controlling operations from the battery pack 130 side on the power tool 101 side, the structure on the power tool 101 side can be simplified. A switch 107 is a rocking switch for ON/OFF controlling the rotation of the motor 104. Additionally, the switch 107 may be changed from a two-contact switch of ON or OFF control to a variable-capacitance switch. In the case when the switch 107 is prepared as the variable-capacitance switch, the rotation speed of the motor 104 can be adjusted by the amount of operation of the switch 107. The FET 108 is disposed between the switch 107 and the negative electrode of the battery cell pack 130, and is normally set to the ON state. Therefore, when the switch 107 is turned ON by the worker, the battery pack 130 and the motor 104 are connected to each other. In contrast, in the event of any abnormality (overcharging, overcurrent, high temperature state, or the like) in the battery pack 130, the FET 108 is turned OFF by the FET control circuit 145 so that the connection between the battery pack 130 and the motor 104 is shut down.

As shown in FIG. 5B, the battery pack 130 is constituted by two lithium ion batteries (battery cells 31a and 31b) that are series-connected to each other. The inter-terminal voltage of the battery pack 130 is monitored by the protective IC 140. The protective IC 140 functions as a battery voltage detection means for detecting a voltage to be supplied from the battery pack 130 to the motor 104, a battery voltage detection means for detecting a voltage at the time of charging the battery pack 130, and a current detection means for detecting an electric current to be supplied from the battery pack 130 to the motor 104. That is, the protective IC 140 is an integrated circuit having a plurality of functions.

In a wiring from the motor 104 to the battery pack 130, shunt resistors 141 are series-connected to one another, and a voltage between the two ends of the shunt resistors 141 is input to the protective IC 140. Therefore, the protective IC 140 is allowed to measure an electric current flowing through the motor 104. In a normal state, the protective IC 140 allows a voltage (signal) corresponding to the battery voltage to be output from an output terminal 140a, while in an over-discharging or overcurrent state, it prevents the signal from being output. In accordance with this signal, the FET control circuit 145 outputs a gate signal to the FET 108 to control the FET 106. The protective IC 140 detects a voltage drop (a voltage drop in proportion to a current) due to a current flowing through the shunt resistors 141, and when the voltage drop has reached a predetermined value or more (a flowing current of a predetermined value or more), it outputs a signal indicating an overcurrent state (hereinafter, referred to as “overcurrent signal”) from the output terminal 140a to the FET control circuit 145. The protective IC 140 further detects a battery voltage of each of the battery cells 31a and 31b such that in the case when even one of the battery cells 31a and 31b has reached a predetermined voltage or less, it prevents the voltage corresponding to the battery voltage from being output from the output terminal 140a to the FET control circuit 145.

In the case when the battery pack 130 is being charged by using the charging device 148, the protective IC 140 exerts a function for monitoring the charging state, and detects the battery voltage of each of the battery cells 31a and 31b, and in the case when even one of the battery cells 31a and 31b has reached a predetermined voltage or more, it outputs a signal (hereinafter, referred to as “overcurrent signal”) from the output terminal 140b to the charging device 148. Upon receipt of this signal, the charging device 148 stops the charging. A thermal protector 142 is a switch that is turned OFF when the temperature has reached a predetermined value or more, and is also turned ON when the temperature is kept at the predetermined value or less. The thermal protector 142 is disposed near the battery cells 31a and 31b, and is turned ON or OFF depending on the temperature of the batteries at the time of discharging or charging. In the case when the battery temperature becomes high during an operation of the power tool 101 (at the time of battery discharging), since the voltage corresponding to the battery voltage is no longer input from the output terminal 140b to the FET control circuit 145, the FET 108 is turned OFF. When the temperature of the battery cells 31a and 31b is raised to exceed a permissible value upon charging, the thermal protector 142 is activated so that the connection between the battery pack 130 and the charging device 148 is disconnected. On the other hand, even in the case when the temperature of the battery cells 31a and 31b has not reached the permissible temperature, the temperature information is fed back to the charging device 148 through the thermistor 143. The thermistor 143, which has its resistance value changed corresponding to its temperature, is disposed near the battery cells 31a and 31b. One of the terminals of the thermistor 143 is connected to the charging device 148 via terminals 149c and 146c. The discrimination resistor 144 is installed so as to discriminate the voltage of the battery cells 31a and 31b (as to whether it is two-cell connection, three-cell connection or the like), and its output is transmitted to the charging device 148 via terminals 149d and 146d.

The FET control circuit 145 controls ON/OFF operations of the FET 108. An overcurrent signal that is output from the output terminal 140a of the protective IC 140 is input to the FET control circuit 145. When the overcurrent signal is at a high level (indicating an overcharging state), the FET control circuit 145 brings the gate signal of the FET 108 to a low state, thereby turning the FET 108 OFF. Moreover, a signal (corresponding to the battery voltage) from the thermal protector 142 is input to the FET control circuit 145. When, during operation of the power tool 101, the battery cells 31a and 31b reach a high temperature, with the result that the thermal protector 142 is activated, the FET control circuit 145 brings the gate signal of the FET 108 to the low state so that the FET 108 is cut off.

When the battery pack 130 is attached to the housing 102 of the power tool 101, contact points 132a, 132b and 132c of the battery pack 130 are connected to terminals 113a, 113b and 113c of the power tool 101. The contact point 132a of the battery pack 130 is connected to the plus terminal of the battery pack 130, with the terminal 113a of the power tool 101 being connected to the plus terminal of the motor 104. The contact point 132b of the battery pack 130 is connected to the FET control circuit 145, with the terminal 113b of the power tool 101 being connected to the FET 108, so that in response to a signal that is input to the terminal 113b, the FET 108 is controlled. The contact point 132c of the battery pack 130 is connected to the minus terminal of the battery pack, with the terminal 113c of the power tool 101 being connected to a source of the FET 108. Electric power is supplied from the battery pack 130 to the motor 104 through the above-mentioned plus contact point 132a, plus terminal 113a, minus contact point 132c and minus terminal 113c.

The charging device 148 is an apparatus for supplying a charging power to the battery pack 130 by using a commercial AC power supply. The battery pack 130 is provided with terminals 149a to 149e, and the charging device 148 is provided with terminals 146a to 146e. When the battery pack 130 is attached to the charging device 148, these terminals are mutually made in contact with one after another to be conducted. The terminal 149a is connected to the plus terminal of the battery pack 130 through the thermal protector 142. The terminal 149b is connected to an output terminal 140b of the protective IC 140 from which “an overcurrent signal” is output. The charging device 148 detects a signal that is output from the protective IC 140 via the terminal 149b, and upon determination of the overcharging state, stops the charging power supply to the battery pack 130. The terminal 149c is connected to the thermistor 143. The charging device 148 detects a value of the thermistor 143 (that is, the current temperature of the battery), and based upon the detected value (battery temperature), adjusts the charging voltage and the charging current. The terminal 149d is connected to the discrimination resistor 144. The charging device 148 discriminates the kinds of batteries (the number of series-connected lithium ion batteries) based upon the detected voltage value, and controls the charging operation based upon the kinds of the batteries thus discriminated. The terminal 149e is connected to the minus terminal of the battery pack 130.

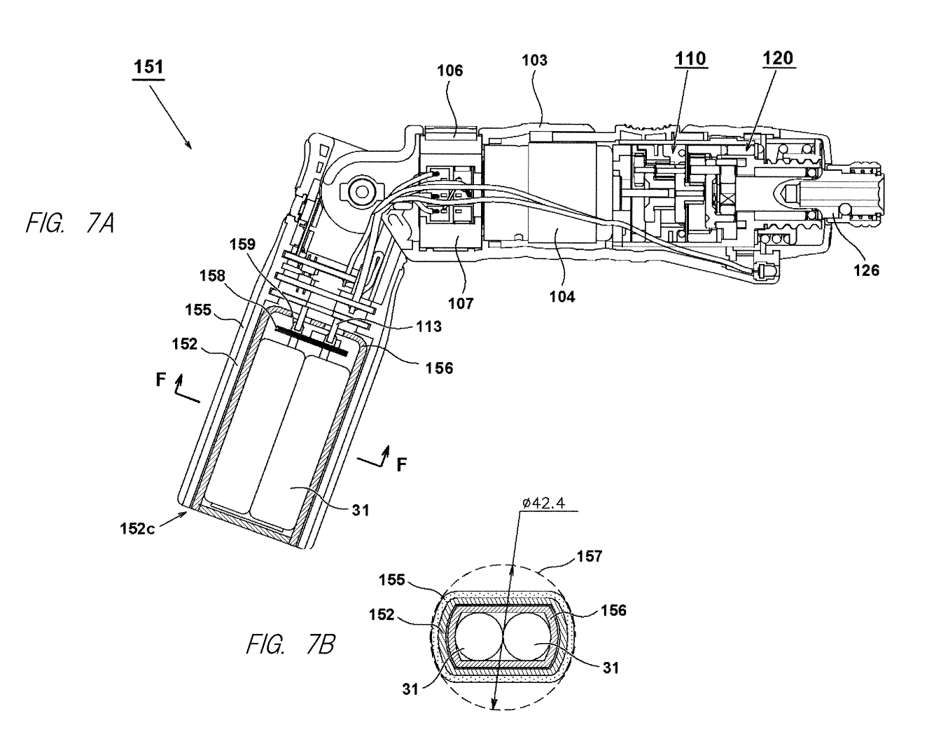

Next, referring to FIGS. 7A and 7B, the following description will explain a first modification example of the power tool in accordance with the present embodiment. FIG. 7A is a longitudinal cross-sectional view that shows the entire structure of a power tool (7.2 V driver drill) in accordance with the present modification example. Moreover, FIG. 7B is a cross-sectional view taken along the F-F portion of FIG. 7A.

A power tool 151 has the same basic structure as that of the power tool 101 shown in FIGS. 5A and 5B except that the shape of a battery pack 156 and its internal layout are changed and that a housing 152 is thinned in its diameter in accordance with the shape of the battery pack 156. Consequently, those members that are the same as those of the power tool 101 are indicated by the same reference numerals. The housing 152 of the power tool 151 in accordance with the present modification example is made to be narrower than the housing 102 of the power tool 101 in accordance with the shape of the battery pack 156. Moreover, the circuit board 158 with the circuit for protecting the battery cell 31 formed thereon is disposed above the battery cell 31 inside the battery pack 156 in parallel with the battery cell 31. The main surface of the circuit board 158 is substantially perpendicular to the axial direction of the battery cell 31. The battery pack 156 has a substantially cylindrical shape being attachable from the opening 152c of the end portion of the housing 152 to the inner space or detachable therefrom, and is of a so-called cassette type.

FIG. 7B is a cross-sectional view taken along the F-F portion of FIG. 7A. The battery pack 156 including two battery cells 31 is housed inside the housing 152. Moreover, when viewed in its cross section, the housing 152 has the minimum size required for housing a case of the battery pack 156 in which the two battery cells 31 and the circuit board 158 are housed. The housing 152 has a cross-sectional shape (outline shape) in which opposing two portions of a circle are squashed to be partially made in parallel with each other. The housing 152 is covered with an elastic member 155 so that a worker feels of elasticity when he or she grabs the housing 152 including the grip portion, and the housing 152 is hardly slippery and easily handled. In the present modification example, the largest outer diameter of the elastic member 155, approximated by a round virtual line 157, is 42.4 mm. That is, the grip portion is sufficiently narrow, and has such a size as to be easily grabbed by most of the workers. The entire portion (or one portion) of the battery pack 156 is allowed to enter the inner space of the grip portion of the housing 152. Not less than half the number of Japanese females who grab the grip portion of the power tool 151 shown in FIG. 7A let their thumb and tip of the index finger touch each other.

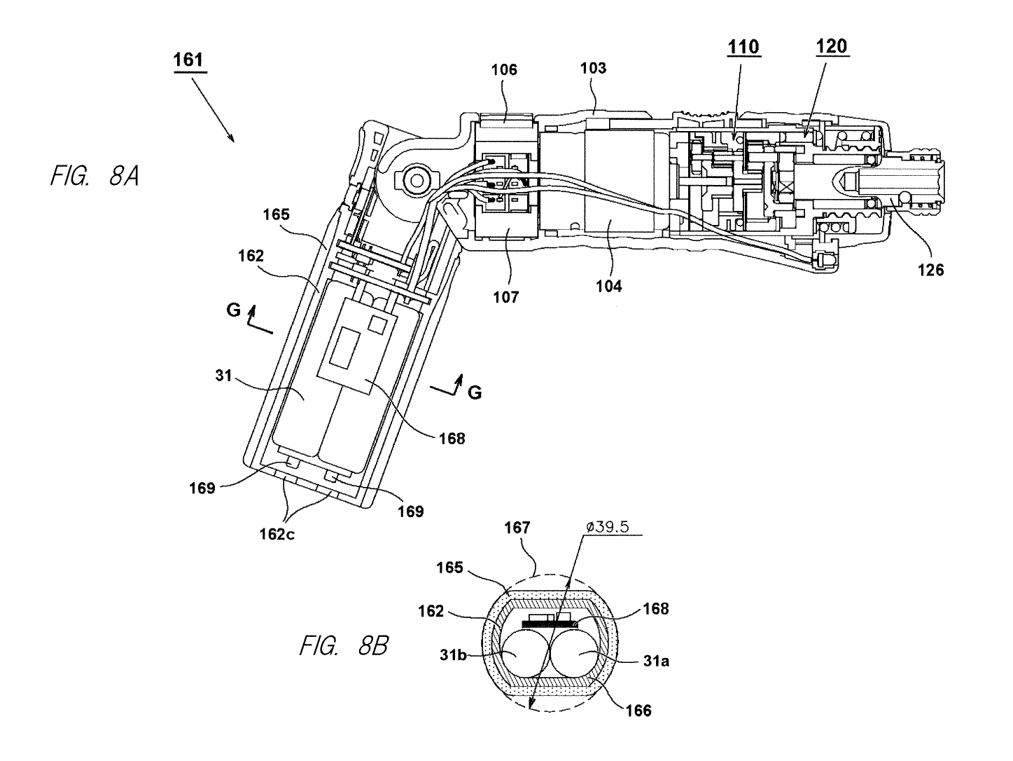

Next, referring to FIGS. 8A and 8B, the following description will explain a second modification example of the power tool in accordance with the present embodiment. FIG. 8A is a longitudinal cross-sectional view that shows the entire structure of a power tool (7.2 V driver drill) in accordance with the present modification example. Moreover, FIG. 8B is a cross-sectional view taken along the G-G portion of FIG. 8A.

In a power tool 161, two battery cells 31 are directly housed inside a housing 162. In other words, the batteries to be used in the power tool 161 are not the pack-type batteries. Moreover, the housing 162 of the power tool 161 is formed into a shape narrower than that of the housing 102 of the power tool 101 shown in FIG. 5, in accordance with the layout of the battery cells 31. Except for the above-mentioned points, the power tool 161 in accordance with the present modification example has basically the same structure as that of the power tool 101 as shown in FIGS. 5A and 5B. Therefore, those members that are the same as those of the power tool 101 are indicated by the same reference numerals. The housing 162 is formed into such a shape as to have a sufficient diameter required for housing the two battery cells 31 and a circuit board 168.

FIG. 8B is a cross-sectional view taken along the G-G portion of FIG. 8A. The two battery cells 31 and the circuit board 168 are housed inside the housing 162. The circuit board 168 is disposed lateral to the battery cells 31 in a manner so as to have its main surface substantially in parallel with the axial direction of the battery cells 31. When viewed in its cross section, the housing 162 has the minimum size required for housing the two battery cells 31 and the circuit board 168. The housing 162 has a cross-sectional shape (outline shape) in which opposing two portions of a circle are squashed to be partially made in parallel with each other. The housing 162 is covered with an elastic member 165. The largest outer diameter of the elastic member 165, approximated by a round virtual line 167, is 39.5 mm. Therefore, the grip portion is sufficiently narrow, and has such a size as to be easily grabbed by most of the workers. Not less than 84% of Japanese females who grab the grip portion of the power tool 161 shown in FIG. 8A have their thumb and tip of the index finger touch each other.

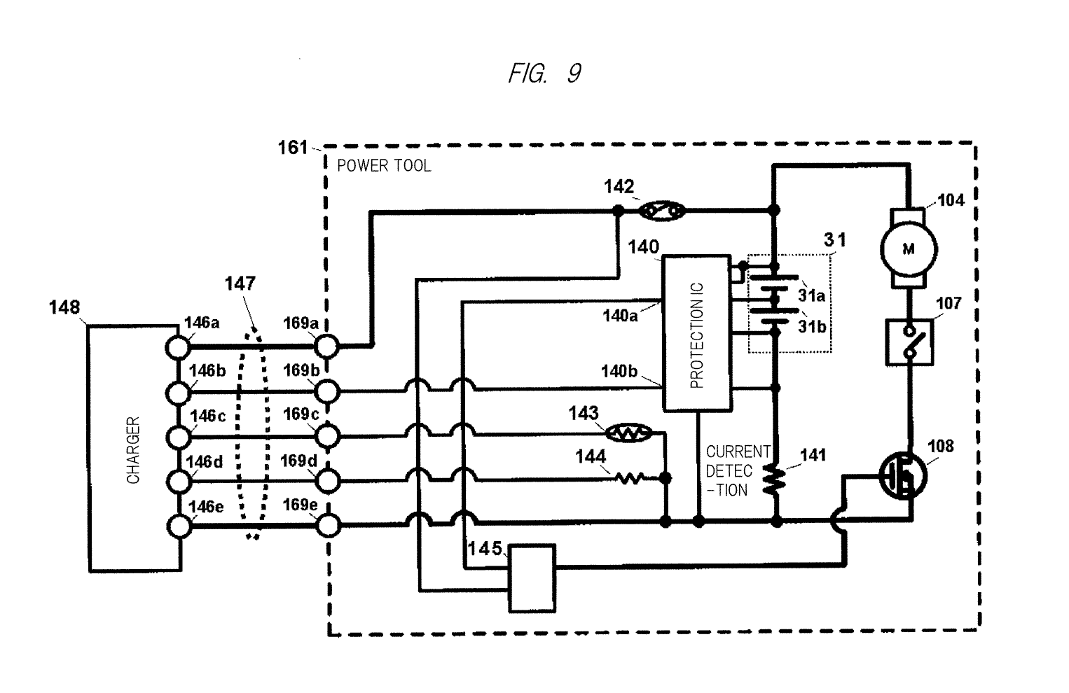

Next, referring to FIG. 9, the following description will explain a circuit configuration relating to the power tool 161 shown in FIG. 8A. The circuit shown in FIG. 9 is substantially the same as the circuit shown in FIG. 6. However, in the present modification example, all the circuits inside the battery pack 130 and the circuits inside the power tool 101 shown in FIG. 6 are disposed inside the power tool 161. In FIG. 9, those components that are the same as the components shown in FIG. 6 are indicated by the same reference numerals. Terminals 146a to 146d of a charging device 148 and terminals 169a to 169d of the power tool 161 are connected to one another through connection cables 147. In the case when charging is required for the battery cells 31a and 31b, sockets of the connection cables 147, not shown, are connected to the terminals 169 via through holes 162c (FIG. 8A) of the power tool 161. During the charging process, the FET 108 is preferably controlled to be OFF so as not to activate the motor 104 even if the switch 107 is turned ON.

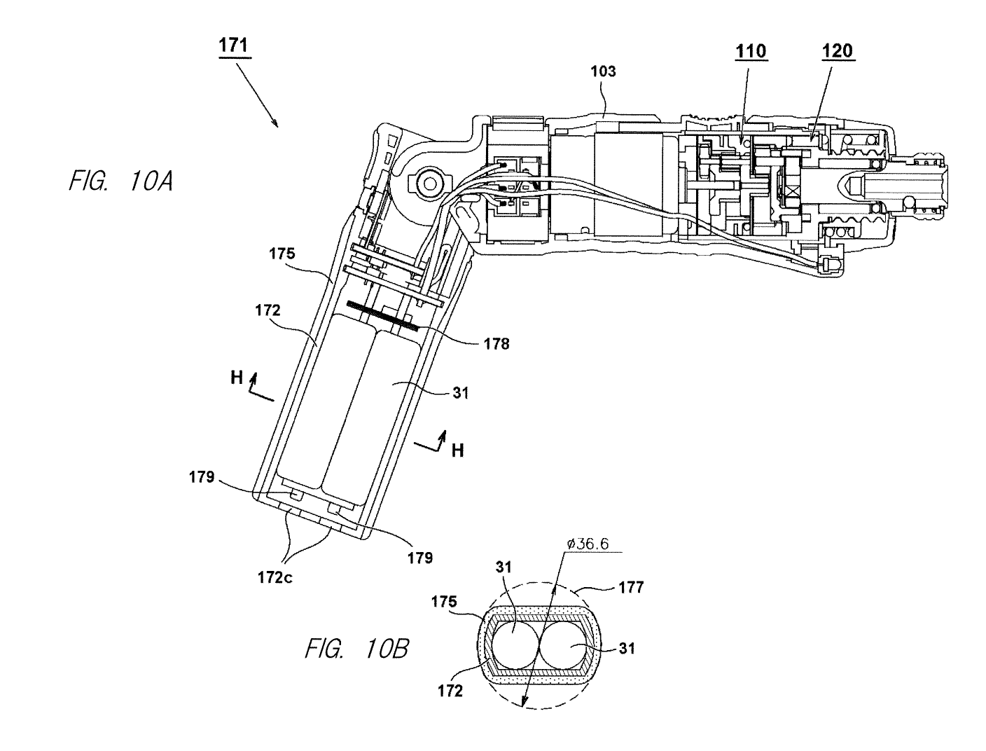

Next, referring to FIGS. 10A and 10B, the following description will explain a third modification example of the power tool in accordance with the present embodiment. FIG. 10A is a longitudinal cross-sectional view that shows the entire structure of a power tool (7.2 V driver drill) in accordance with the present modification example. Moreover, FIG. 10B is a cross-sectional view taken along the H-H portion of FIG. 10A.

In a power tool 171, two battery cells 31 are directly housed inside a housing 172. In other words, the batteries to be used in the power tool 171 are not the pack-type batteries. In this case, a circuit board 178 is disposed above the battery cells 31. Moreover, the housing 172 of the power tool 171 is formed into a shape that is further narrower than the housing 162 of the power tool 161 shown in FIG. 8A, in accordance with the layout of the battery cells 31 and the circuit board 178. Except for the above-mentioned points, the power tool 171 in accordance with the present modification example has basically the same structure as that of the power tool 161 as shown in FIGS. 8A and 8B. Therefore, those members that are the same as those of the power tool 161 are indicated by the same reference numerals. The housing 172 is formed into such a shape as to have a sufficient diameter required for housing the two battery cells 31. The circuit board 178 is disposed above the battery cells 31 in a manner so as to have its surface substantially perpendicular to the axial direction of the battery cells 31.

FIG. 10B is a cross-sectional view taken along the H-H portion of FIG. 10A. The two battery cells 31 are housed inside the housing 172. When viewed in its cross section, the housing 172 has the minimum size required for housing the two battery cells 31. The housing 172 has a flattened cross-sectional shape (outline shape) in which opposing two portions of a circle are squashed to be partially made in parallel with each other. The housing 172 is covered with an elastic member 175. The largest outer diameter of the elastic member 175, approximated by a round virtual line 177, is 36.6 mm. Therefore, the grip portion is extremely narrow, and has such a size as to be easily grabbed by most of workers. Not less than 96% of Japanese females who grab the grip portion of the power tool 171 shown in FIG. 10A have their thumb and tip of the index finger allowed to touch each other.

As described above, the power tool relating to the second embodiment and modification examples thereof is provided with two thin-type lithium ion batteries having light weight and a small size with a diameter of 14 mm, which are mounted thereon. Moreover, these lithium ion batteries are a type of built-in in the main body or a pack type capable of being detachably attached, and are housed in a grip portion of a power tool main body. Therefore, it becomes possible to achieve light weight and a small size of the power tool main body, and also to provide a power tool that is easily grabbed by both of males and females, and can be easily handled.

### Third Embodiment

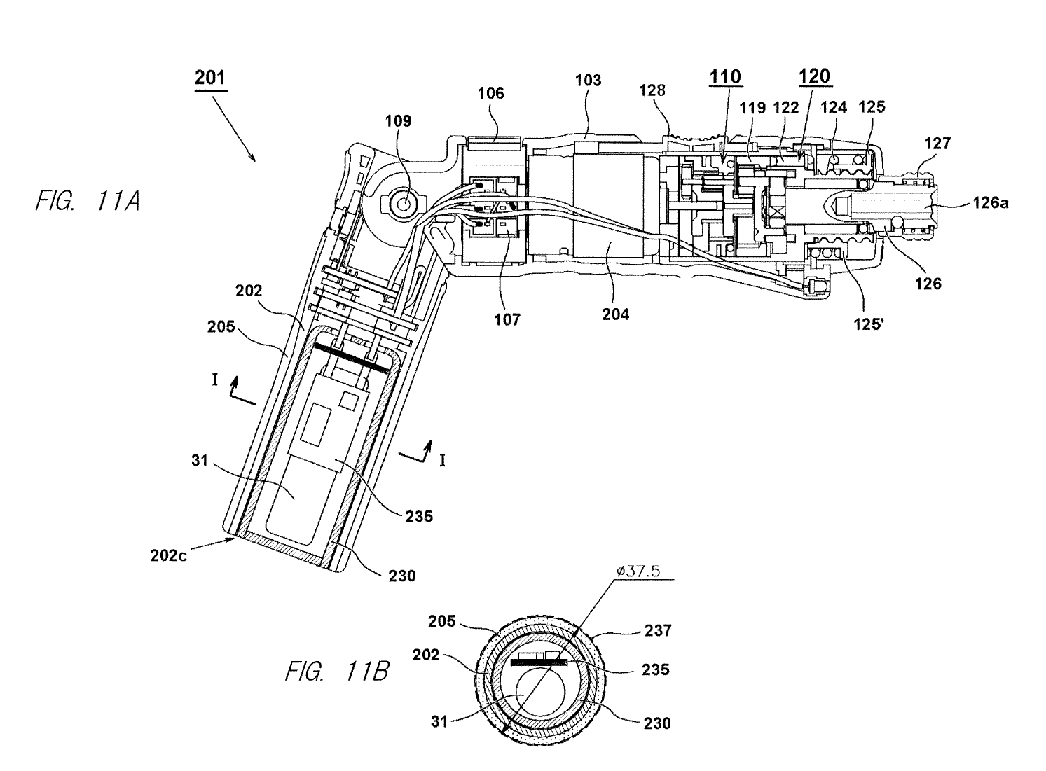

Referring to FIG. 11, the following description will explain a third embodiment of a power tool in accordance with the present invention. The power tool of the present embodiment is a driver drill in which one lithium ion battery (battery cell 31) of the 14500 size is used. FIG. 11A is a longitudinal cross-sectional view showing the entire structure of a power tool 201 (3.6 V driver drill) in accordance with the present embodiment. Moreover, FIG. 11B is a cross-sectional view taken along the I-I portion of FIG. 11A.

Except for the points that only one battery cell 31 is housed in a battery pack 230 and that a motor 204 is altered in accordance with the voltage of the battery pack 230, a power tool 201 has the same basic structure as that of the power tool 101 according to the second embodiment. Therefore, those members that are the same as those of the power tool 101 are indicated by the same reference numerals. In particular, those members inside the motor housing 103 are same as those of the power tool 101 except for a motor 204. The shape of the housing 202 is formed to be narrower than the housing 102 of the power tool 101, in accordance with the shape of the battery pack 230. The battery pack 230 is a so-called cassette-type battery pack having a substantially cylindrical shape, which can be attached from an opening 202c at the end portion of the housing 202 to the inner space or detached therefrom.

FIG. 11B is a cross-sectional view taken along the I-I portion of FIG. 11A. In the battery pack 230 to be housed in the housing 202, one battery cell 31 is housed. Moreover, a circuit board 235 having a circuit for protecting the battery cell 31 mounted thereon is disposed to be lateral to the battery cell 31. A surface of the circuit board 235 is parallel to the axial direction of the battery cell 31. When viewed in its cross section, the housing 202 has the minimum size required for housing the circuit board 235 and the one battery cell 31. The housing 202 has a round cross-sectional shape (outline shape). In the present embodiment also, the housing 202 is covered with an elastic member 205 so that a worker feels elasticity when he or she grabs the housing 202 including the grip portion, and the grip portion is hardly slippery and easily handled. In the present embodiment, the largest outer diameter of the elastic member 205, approximated by a round virtual line 237, is 37.5 mm. That is, the grip portion is sufficiently narrow, and easily grabbed by most of workers. The battery pack 230 has its entire portion (or one portion) allowed to enter a space inside the grip portion of the housing 202. The average value of the inner diameters of the grip (index finger) of Japanese females is 37.5 mm and the standard deviation a thereof is 2.68 mm. Therefore, with respect to not less than half the number of females who grab the grip portion of the power tool 201 shown in FIG. 11A, the thumb and the tip of the index finger are allowed to touch each other.

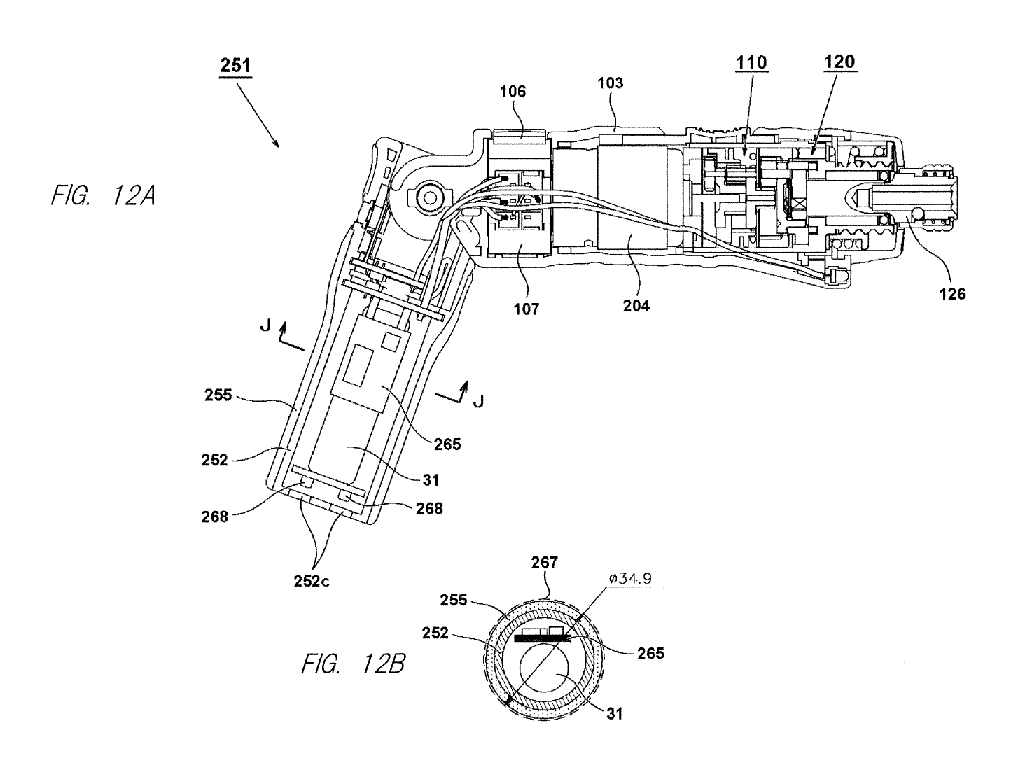

Next, referring to FIGS. 12A and 12B, the following description will explain a first modification example of the power tool according to the present embodiment. A power tool 251 in accordance with the present modification example has the same basic structure as that of the power tool 201 shown in FIG. 11A except that one battery cell 31 is directly disposed inside a housing 252, with no changes being made in the inner structure of the motor housing 103. The battery cell 31 is not of a pack type capable of being detachably attached. That is, the user is not allowed to detachably attach the battery cell 31. On the other hand, the shape of the housing 252 is formed to be thinner than that of the housing 202 of the power tool 2001 shown in FIG. 11A.

FIG. 12B is a cross-sectional view taken along the J-J portion of FIG. 12A. One battery cell 31 is housed inside the housing 252. Moreover, a circuit board 265 with a circuit for protecting the battery cell 31 mounted thereon is disposed lateral to the battery cell 31. The circuit board 265 is disposed with its surface being made substantially in parallel with the axial direction of the battery cell 31. When viewed in its cross section, the housing 252 has the minimum size required for housing the one battery cell 31 and the circuit board 265. The housing 252 has a round cross-sectional shape (outline shape). The housing 252 is covered with an elastic member 255 so that a worker feels elasticity when he or she grabs the housing 252 including the grip portion, and the grip portion is hardly slippery and easily handled. In the present embodiment, the largest outer diameter of the elastic member 255, approximated by a round virtual line 267, is 34.9 mm. That is, the grip portion is sufficiently narrow, and easily grabbed by most of workers. Not less than 84% of Japanese females who grab the grip portion of the power tool 251 shown in FIG. 12A have their thumb and tip of the index finger allowed to touch each other.

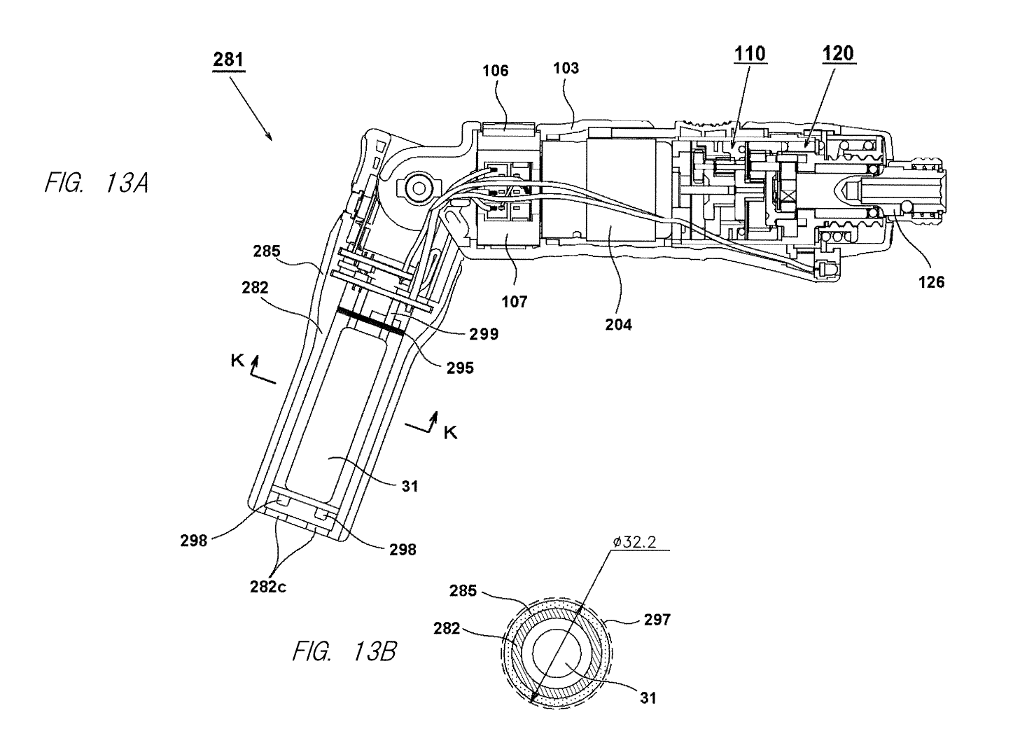

Next, referring to FIGS. 13A and 13B, the following description will explain a second modification example of the power tool in accordance with the present embodiment. A power tool 281 has the same basic structure as that of the power tool 201 shown in FIG. 11A except that one battery cell 31 is directly disposed inside a housing 282, with no changes being made in the inner structure of the motor housing 103. The shape of the housing 282 is formed to be slightly narrower than that of the housing 252 of the power tool 251 shown in FIG. 12A. A circuit board 295 having a circuit for protecting the battery cell 31 mounted thereon is disposed above the battery cell 31. The circuit board 295 is disposed with its surface being made substantially perpendicular to the axial direction of the battery cell 31. Additionally, the circuit board 295 may be disposed not above the battery cell 31, but below the battery cell 31. In this manner, the battery is built inside the housing 282 without using the pack-type battery. For this reason, a charging terminal (terminal 298) and a discharging terminal 299 can be distinguished from each other so that the charging terminal 298 can be installed on a lower portion of the main body of the power tool 281. Therefore, electric power can be supplied from an external charging device, not shown, to the battery through the charging terminal 298. Moreover, by placing the discharging terminal 299 closer to the motor driving unit, it becomes possible to make the wiring shorter.

FIG. 13B is a cross-sectional view taken along the K-K portion of FIG. 13A. One battery cell 31 is housed inside the housing 282. When viewed in its cross section, the housing 282 has the minimum size required for housing the one battery cell 31. The housing 282 has a round cross-sectional shape (outline shape). The housing 282 is covered with an elastic member 285. In the present modification example, the largest outer diameter of the elastic member 285, approximated by a round virtual line 297, is 32.2 mm. Therefore, the grip portion is sufficiently thin, and easily grabbed by most of workers. Not less than 96% of Japanese females who grab the grip portion of the power tool 281 shown in FIG. 13A have their thumb and tip of the index finger touching each other. As described above, in accordance with the power tool relating to the third embodiment, the diameter of the grip portion is 37.5 mm or less. Moreover, the diameter of the grip portion can be thinned to about 32.2 mm. Additionally, when reference is made to FIG. 13B, it looks as if the housing 282 could be further thinned. However, since the diameter (outer diameter) of the battery cell 31 is 14 mm, it cannot be thinned to not more than the total of 14 mm+the thickness of the housing 282.

As described above, in the power tool relating to the third embodiment and the modification examples thereof, a thin-type lithium ion battery having light weight and a small size with 14 mm in diameter can be installed. Moreover, the lithium ion battery is of the main-body built-in type or of the packed type capable of being detachably attached, and can be housed in the grip portion of the power tool main body. Therefore, it is possible to achieve a power tool main body having light weight and a small size, and consequently to provide a power tool that can be easily grabbed by both of males and females and can be more easily handled. Furthermore, by disposing the protective substrate for the lithium ion battery above or below the lithium ion battery, the grip portion can be further thinned in its diameter.

Although the present invention has been described above by way of the embodiments and modification examples thereof, it is needless to say that the invention is not limited to the above-described embodiments and modification examples, but that various changes may be made within the scope not departing from the gist of the invention. For example, in the present specification, an impact tool and a driver drill are exemplified as a power tool; however, the present invention may be applied to another power tool of a cordless type with a grip portion.

What is claimed is:

1. A power tool using a lithium ion secondary battery as a driving source,
wherein the lithium ion secondary battery has an actual diameter of 14 mm or less;
when a switch installed in a main body of the power tool is operated, the lithium ion secondary battery is connected to a driving unit including a motor so that the power tool is activated;
the lithium ion secondary battery and a protective circuit for protecting the lithium ion secondary battery are installed inside an independent battery pack that is capable of being detachably attached to the power tool;
the battery pack is inserted into an inside of a grip portion of the power tool main body;
three of the lithium ion secondary batteries are installed inside the battery pack side by side in the same direction as an axial direction of the grip portion; and
the grip portion has a maximum diameter of 51.8 mm or less.

2. The power tool according to claim 1,
wherein the protective circuit is disposed lateral to the lithium ion secondary batteries in parallel with the axial direction of the grip portion.

3. The power tool according to claim 1,
wherein the protective circuit is disposed above or below the lithium ion secondary batteries; and
the grip portion has a maximum diameter of 48.6 mm or less.

4. A power tool using a lithium ion secondary battery as a driving source,
wherein the lithium ion secondary battery has an actual diameter of 14 mm or less;
when a switch installed in a main body of the power tool is operated, the lithium ion secondary battery is connected to a driving unit including a motor so that the power tool is activated;
wherein three of the lithium ion secondary batteries are installed in a grip portion of the power tool in a manner so as to have the same axis as an axial direction of the grip portion; and
the grip portion has a maximum diameter of 45.6 mm or less.

5. The power tool according to claim 4,
wherein the protective circuit is disposed lateral to the lithium ion secondary batteries in parallel with the axial direction of the grip portion.

6. The power tool according to claim 4,
wherein the protective circuit is disposed above or below the lithium ion secondary battery, with the grip portion having a maximum diameter of 42.5 mm or less.

7. A power tool using a lithium ion secondary battery as a driving source,
wherein the lithium ion secondary battery has an actual diameter of 14 mm or less;
when a switch installed in a main body of the power tool is operated, the lithium ion secondary battery is connected to a driving unit including a motor so that the power tool is activated;
the lithium ion secondary battery and a protective circuit for protecting the lithium ion secondary battery are installed inside an independent battery pack that is capable of being detachably attached to the power tool;
the battery pack is inserted into an inside of a grip portion of the power tool main body;
two of the lithium ion secondary batteries are installed in the battery pack so as to have the same axis as an axial direction of the grip portion; and
the grip portion has a maximum diameter of 45.3 mm or less.

8. The power tool according to claim 7,
wherein the protective circuit is disposed lateral to the lithium ion secondary batteries in parallel with the axial direction of the grip portion.

9. The power tool according to claim 7,
wherein the protective circuit is disposed above or below the lithium ion secondary batteries, with the grip portion having a maximum diameter of 42.4 mm or less.

10. A power tool comprising using a lithium ion secondary battery as a driving source,
wherein the lithium ion secondary battery has an actual diameter of 14 mm or less;
when a switch installed in a main body of the power tool is operated, the lithium ion secondary battery is connected to a driving unit including a motor so that the power tool is activated;
two of the lithium ion secondary batteries are installed inside a grip portion of the power tool so as to have the same axis as an axial direction of the grip portion; and
the grip portion has a maximum diameter of 39.5 mm or less.

11. The power tool according to claim 10,
wherein the protective circuit is disposed lateral to the lithium ion secondary batteries in parallel with the axial direction of the grip portion.

12. The power tool according to claim 10,
wherein the protective circuit is disposed above or below the lithium ion secondary battery; and
the grip portion having a maximum diameter of 36.6 mm or less.

13. A power tool using a lithium ion secondary battery serving a driving source,
wherein the lithium ion secondary battery has an actual diameter of 14 mm or less;
when a switch installed in a main body of the power tool is operated, the lithium ion secondary battery is connected to a driving unit including a motor so that the power tool is activated;
the lithium ion secondary battery and a protective circuit for protecting the lithium ion secondary battery are installed inside an independent battery pack that is detachably attached to the power tool;
the battery pack is inserted into an inside of a grip portion of the power tool main body;
the single lithium ion secondary battery is housed in the battery pack; and
the grip portion has a maximum diameter of 37.5 mm or less.

14. The power tool according to claim 13, wherein the protective circuit is disposed lateral to the lithium ion secondary battery in parallel with the axial direction of the grip portion.

15. A power tool using a lithium ion secondary battery as a driving source,
wherein the lithium ion secondary battery has an actual diameter of 14 mm or less;
when a switch installed in a main body of the power tool is operated, the lithium ion secondary battery is connected to a driving unit including a motor so that the power tool is activated;
the single lithium ion secondary battery is installed inside a grip portion of the power tool; and
the grip portion has a maximum diameter of 34.9 mm or less.

16. The power tool according to claim 15,
wherein the protective circuit is disposed lateral to the lithium ion secondary battery in parallel with the axial direction of the grip portion.

17. The power tool according to claim 15,
wherein the protective circuit is disposed above or below the lithium ion secondary battery; and
the grip portion has a maximum diameter of 32.2 mm or less.
